(19) United States
(12) Patent Application Publication
(10) Pub. No.: US 2020/0336665 A1
(43) Pub. Date: Oct. 22, 2020

(54) DISPLAY CONTROL APPARATUS, CONTROL METHOD, AND STORAGE MEDIUM

(71) Applicant: CANON KABUSHIKI KAISHA, Tokyo (JP)

(72) Inventor: Takashi Matsui, Yokohama-shi (JP)

(21) Appl. No.: 16/838,652

(22) Filed: Apr. 2, 2020

(30) Foreign Application Priority Data
Apr. 19, 2019 (JP) 2019-080189

(51) Int. Cl. H04N 5/232

(52) U.S. Cl. CPC H04N 5/23293; H04N 5/23212; H04N 5/23232

(57) ABSTRACT

A display control apparatus includes a display control unit configured to perform control to display a live view image acquired from an image pickup unit on a display unit, a receiving unit configured to receive an instruction to display a first item on the display unit, in a case where the live view image is being displayed on the display unit, and a control unit configured to control a frame rate for displaying the live view image to be lower in a case where the first item is displayed on the display unit, than in a case where the first item is not displayed on the display unit.

### BACKGROUND

### Field of the Disclosure

The present disclosure generally relates to display control and, more particularly, to a display control apparatus, a control method, a storage medium, and a technique of displaying a live view image.

### Description of the Related Art

Conventionally, in a display of a live view image for an apparatus such as a digital camera, a motion close to an actual motion of a subject can be displayed by increasing a display frame rate for the live view image.

Japanese Patent Application Laid-Open No. 2017-139641 discusses a technique that starts operation of an image pickup unit at a high frame rate at start-up, and sets a normal driving mode employing a normal frame rate, in a case where a movement amount of a subject is determined to be less than or equal to a first threshold.

In Japanese Patent Application Laid-Open No. 2017-139641, even when a user views an item displayed on a display unit other than a live view image, the item is also displayed at a high frame rate and therefore, power consumption may not be reduced.

### SUMMARY

The present disclosure is directed to a display control apparatus capable of reducing power consumption in a case where a live view image is displayed on a display unit.

According to an aspect of the present disclosure, a display control apparatus includes a display control unit configured to perform control to display a live view image acquired from an image pickup unit on a display unit, a receiving unit configured to receive an instruction to display a first item on the display unit, in a case where the live view image is being displayed on the display unit, and a control unit configured to control a frame rate for displaying the live view image to be lower in a case where the first item is displayed on the display unit, than in a case where the first item is not displayed on the display unit.

Further features of the present disclosure will become apparent from the following description of exemplary embodiments with reference to the attached drawings.

### BRIEF DESCRIPTION OF THE DRAWINGS

FIGS. 1A and 1B are external views of a digital camera according to one or more aspects of the present disclosure.

FIG. 2 is a block diagram schematically illustrating a hardware configuration example of the digital camera according to one or more aspects of the present disclosure.

FIGS. 3A and 3B are block diagrams schematically illustrating a hardware configuration example of an image pickup unit, according to one or more aspects of the present disclosure.

FIGS. 4A and 4B are diagrams illustrating readout timing of the image pickup unit, according to one or more aspects of the present disclosure.

FIGS. 5A, 5B, 5C, 5D, and 5E are diagrams each illustrating a display example on a display unit, according to one or more aspects of the present disclosure.

FIG. 6 is a flowchart illustrating display control processing for a live view image, according to one or more aspects of the present disclosure.

### DESCRIPTION OF THE EMBODIMENTS

Various exemplary embodiments, features, and aspects of the present disclosure will be described below with reference to the drawings.

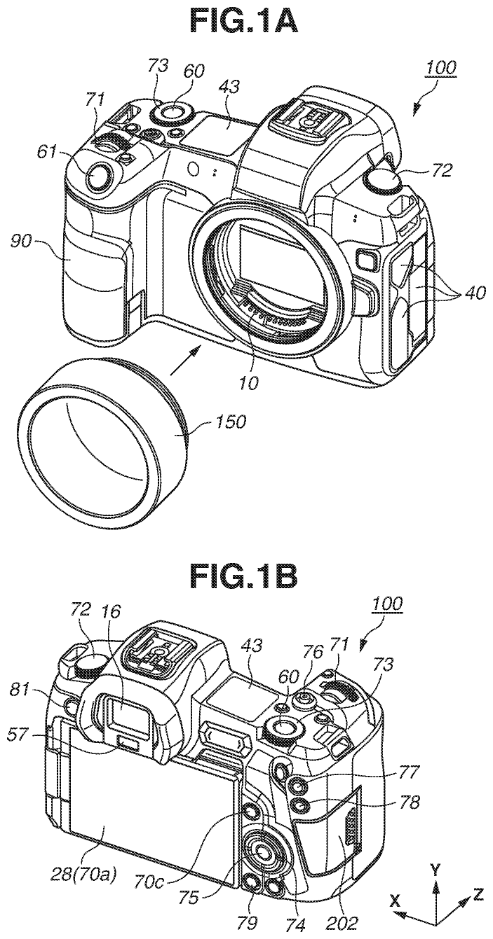

FIGS. 1A and 1B each illustrate an external view of a digital camera 100 as an example of an apparatus to which the present disclosure is applicable. FIG. 1A is a front face perspective view of the digital camera 100, and FIG. 1B is a back face perspective view of the digital camera 100. In FIG. 1B, a display unit 28 is provided on a camera back face and displays an image and various kinds of information.

A touch panel 70a can detect a touch operation on a display screen (operation surface) of the display unit 28. A viewfinder external display unit 43 is provided on a camera top surface, and displays various setting values of the digital camera 100, including a shutter speed and an aperture value.

A shutter button 61 is an operation member for providing an image capturing instruction. A mode selection switch 60 is an operation member for switching between various modes.

A quick setting button 70c (hereinafter referred to as “Q button 70c”) is a push button switch included in an operation unit 70. A quick setting menu that is a list of setting items that can be set in each operating mode is displayed by pressing the Q button 70c. For example, when the Q button 70c is pressed during live view (LV) display, a list of setting items, such as automatic focus (AF) setting, continuous image-capturing setting, recording image quality, brightness of a monitor, white balance (WB) of an LV display screen, and color shade, is displayed in a state of being superimposed on a live view. A user can select any option in the quick setting menu as a selected setting item, and change settings related to the selected setting item or shift to an operation mode, by using the touch panel 70a and members such as a cross key 74 and a SET button 75.

A terminal cover 40 protects a connector (not illustrated) that connects a connection cable for connecting an external apparatus to the digital camera 100.

A main electronic dial 71 is a rotational operation member included in the operation unit 70. For example, the user can change a setting value such as a shutter speed or an aperture value, by turning the main electronic dial 71.

A power switch 72 is an operation member for switching between power-on and power-off of the digital camera 100. A sub electronic dial 73 is a rotational operation member included in the operation unit 70. For example, the user can move a selection frame or perform image feeding, by operating the sub electronic dial 73.

The cross key 74 is a cross key (four-direction key) included in the operation unit 70. Upper, lower, left, and right portions of the cross key 74 can each be pressed. The user can perform an operation corresponding to the pressed portion of the cross key 74. The SET button 75 is a push button included in the operation unit 70, and is mainly used for determination of the selected item.

A moving image button 76 is used to provide an instruction for starting or stopping moving-image capturing (recording). An automatic exposure (AE) lock button 77 is included in the operation unit 70. The user can hold an exposure state, by pressing the AE lock button 77 in an image capturing standby state. A zoom button 78 is an operation button included in the operation unit 70, to bring the expansion mode into an ON state or an OFF state, in live view display of an image capturing mode. The user can enlarge or reduce a live view image, by operating the main electronic dial 71 after brining the expansion mode into the ON state. In a playback mode, the zoom button 78 serves as a button for increasing a magnification rate to enlarge a playback image. A playback button 79 is an operation button included in the operation unit 70, to switch between the image capturing mode and the playback mode. The user can shift the mode to the playback mode by pressing the playback button 79 in the image capturing mode, so that the latest image among images recorded in a storage medium 200 to be described below can be displayed on the display unit 28.

A menu button 81 is included in the operation unit 70. A menu screen in which various kinds of settings are settable is displayed on the display unit 28, by pressing the menu button 81. The user can intuitively perform various kinds of settings, using the menu screen displayed on the display unit 28, the cross key 74, and the SET button 75.

A communication terminal 10 is provided for communication between the digital camera 100 and a lens unit 150 (attachable/detachable).

An eyepiece portion 16 is included in an eyepiece viewfinder (look-in-type viewfinder). The user can visually recognize an image displayed on an electronic viewfinder (EVF) 29 provided inside, via the eyepiece portion 16. The EVF 29 will be described in detail below. An eye approach detection unit 57 is a sensor that detects whether an object is approaching the eyepiece portion 16.

A lid 202 is provided to cover a slot that stores the storage medium 200.

A grip portion 90 is a holding portion that has a shape for the user to easily grip the grip portion 90 with the right hand when holding the digital camera 100. The shutter button 61 and the main electronic dial 71 are disposed at the respective positions that enable these members to be operated with the forefinger of the right hand, in a state where the user holds the digital camera 100 by gripping the grip portion 90 with the little finger, the third finger, and the middle finger of the right hand. Further, the sub electronic dial 73 is disposed at a position that enables this member to be operated with the thumb of the right hand, in the same state.

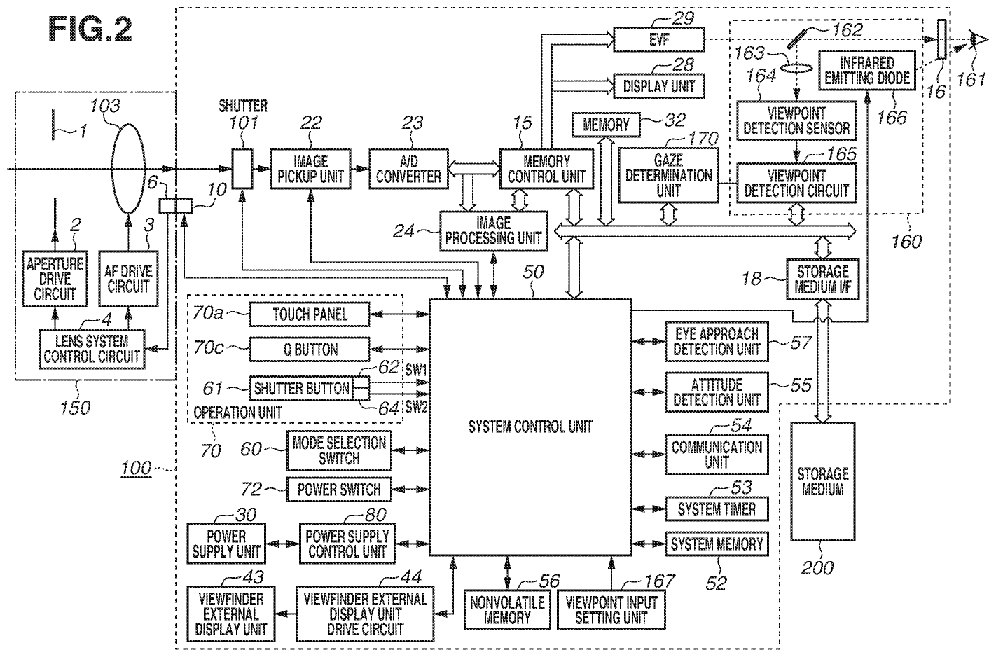

FIG. 2 is a block diagram illustrating a configuration example of the digital camera 100 according to the present exemplary embodiment. In FIG. 2, the lens unit 150 is an interchangeable lens unit and equipped with an image capturing lens. A lens 103 is typically configured of a plurality of lenses, but is illustrated as only one lens for simplicity. A communication terminal 6 is provided for the lens unit 150 to communicate with the digital camera 100. The lens unit 150 communicates with a system control unit 50, via the communication terminal 6 and the communication terminal 10 described above. This communication enables a lens system control circuit 4 provided inside the lens unit 150 to control an aperture unit 1 via an aperture drive circuit 2, and move the lens 103 via an AF drive circuit 3 to perform focusing.

A shutter 101 is a focal plane shutter that can control an exposure period of an image pickup unit 22 based on control by the system control unit 50.

The image pickup unit 22 is an image sensor that converts an optical image into an electrical signal and is configured of a sensor such as a charge coupled device (CCD) sensor or a complementary metal oxide semiconductor (CMOS) sensor. An analog-to-digital (A/D) converter 23 is used to convert an analog signal output from the image pickup unit 22 into a digital signal.

An image processing unit 24 performs predetermined pixel interpolation, resizing processing such as reduction, and color conversion processing, on data from the A/D converter 23 or data from a memory control unit 15 to be described below. Further, the image processing unit 24 performs predetermined calculation processing, using picked-up image data. The system control unit 50 performs exposure control and ranging control, based on a calculation result obtained by the image processing unit 24. AF processing, AE processing of a through-the-lens (TTL) method, and electronic flash (EF) (i.e., pre-flash) processing are thereby performed. The image processing unit 24 further performs predetermined calculation processing using the picked-up image data to perform automatic white balance (AWB) processing of the TTL method, based on a calculation result obtained by this processing.

The memory control unit 15 controls data transmission and reception between the A/D converter 23, the image processing unit 24, and a memory 32. Output data output from the A/D converter 23 is written into the memory 32, via the image processing unit 24 and the memory control unit 15, or directly via the memory control unit 15. The memory 32 stores image data obtained by the image pickup unit 22 and converted into digital data by the A/D converter 23, and image data to be displayed on the display unit 28 or the EVF 29. The memory 32 has a capacity sufficient for storing a predetermined number of still images and a predetermined length of a moving image and sound.

The memory 32 also serves as a memory for image display (video memory). The image data for display written in the memory 32 is displayed on the display unit 28 or the EVF 29 via the memory control unit 15. The display unit 28 and the EVF 29 each perform display based on a signal from the memory control unit 15, on a display device such as a liquid crystal display (LCD) or an organic electroluminescence (EL) display. The data subjected to the AD conversion by the A/D converter 23 and accumulated in the memory 32 is transferred to and then displayed on the display unit 28 or the EVF 29 one by one, so that the LV display can be performed. An image displayed as a live view will be hereinafter referred to as a live view image (LV image).

An infrared emitting diode 166 is a light emitting element for detecting a viewpoint position of the user within a viewfinder screen, and emits infrared light to an eyeball (eye) 161 of the user. The infrared light emitted from the infrared emitting diode 166 is reflected by the eyeball (eye) 161, and the reflected infrared light arrives at a dichroic mirror 162. The dichroic mirror 162 reflects only infrared light and allows visible light to pass therethrough. The reflected infrared light with its optical path changed forms an image on an image pickup plane of a viewpoint detection sensor 164 via an image forming lens 163. The image forming lens 163 is an optical member that forms a viewpoint detection optical system. The viewpoint detection sensor 164 is configured of an image pickup device such as a CCD image sensor.

The viewpoint detection sensor 164 photoelectrically converts the incident reflected infrared light into an electrical signal, and outputs the electrical signal to a viewpoint detection circuit 165. Based on the signal output from the viewpoint detection sensor 164, the viewpoint detection circuit 165 detects a viewpoint position of the user based on a motion of the eyeball (eye) 161 of the user, and outputs detection information obtained thereby to the system control unit 50 and a gaze determination unit 170. In this way, the dichroic mirror 162, the image forming lens 163, the viewpoint detection sensor 164, the infrared emitting diode 166, and the viewpoint detection circuit 165 are included in a viewpoint detection unit 160, and the eyepiece portion 16 has a function as a viewpoint operation unit. Other types of viewpoint detection unit may be employed.

The gaze determination unit 170 has a predetermined threshold. In a case where a time during which a viewpoint of the user is fixed in a certain region exceeds the predetermined threshold, the gaze determination unit 170 determines that the user is gazing at this region, based on the detection information received from the viewpoint detection circuit 165. The predetermined threshold can be optionally changed.

In the viewfinder external display unit 43, various setting values of the digital camera 100, including the shutter speed and the aperture value, are displayed via a viewfinder external display unit drive circuit 44

A nonvolatile memory 56 is an electrically erasable and recordable memory, and, for example, a flash read only memory (ROM) is used for the nonvolatile memory 56. The nonvolatile memory 56 stores, for example, a constant for operation of the system control unit 50, and a program. The program mentioned here is a program for executing a flowchart to be described below in the present exemplary embodiment.

The system control unit 50 is configured of at least one processor or circuit, and controls the entire digital camera 100. The system control unit 50 executes the above-described program stored in the nonvolatile memory 56, so that each process to be described below of the present exemplary embodiment is implemented. For a system memory 52, for example, a random access memory (RAM) is used. For example, a constant and a variable required for operating the system control unit 50 as well as a program read out from the nonvolatile memory 56 are loaded into the system memory 52. The system control unit 50 also performs display control by controlling components such as the memory 32 and the display unit 28.

A system timer 53 is a timer unit that measures a time to be used for various kinds of control and the time of a built-in clock.

Each of the mode selection switch 60 and the operation unit 70 is an operation unit for inputting various operation instructions into the system control unit 50. The mode selection switch 60 switches an operating mode of the system control unit 50 to any of mode including a still image capturing mode and a moving-image capturing mode. The still image capturing mode includes modes such as an automatic image capturing mode, an automatic scene determination mode, a manual mode, an aperture priority mode (Av mode), a shutter-speed priority mode (Tv mode), and a program AE mode (P mode). There are also other modes such as various scene modes each providing setting for the corresponding image-capturing scene, and a custom mode. The user can directly switch to any one of these modes, using the mode selection switch 60. Alternatively, the user may switch to a screen for a list of the modes included in the image capturing mode and select any one of the displayed modes using the mode selection switch 60, and then switch to any other mode using another operation member. The moving-image capturing mode may similarly include a plurality of modes.

A first shutter switch 62 generates a first shutter switch signal SW1, when it is turned on by a half press (image-capturing preparation instruction), during an operation on the shutter button 61 provided on the digital camera 100. Image-capturing preparation operation including the AF processing, the AE processing, the AWB processing, and the EF processing starts in response to the first shutter switch signal SW1.

A second shutter switch 64 generates a second shutter switch signal SW2, when it is turned on by completion of an operation on the shutter button 61, i.e., a full press (image capturing instruction). In response to the second shutter switch signal SW2, the system control unit 50 starts operation of a series of image capturing processes, from readout of a signal from the image pickup unit 22, to writing of a picked-up image into the storage medium 200 as an image file.

The operation unit 70 is a group of various operation members each serving as an input member that receives an operation from the user. The operation unit 70 includes at least the following operation portions, in addition to the touch panel 70a and the Q button 70c. The operation members are the shutter button 61, the main electronic dial 71, the power switch 72, the sub electronic dial 73, the cross key 74, the SET button 75, the moving image button 76, the AE lock button 77, the zoom button 78, the playback button 79, and the menu button 81.

A power supply control unit 80 includes a battery detection circuit, a direct current to direct current (DC-DC) converter, and a switch circuit for switching between blocks to be energized. The power supply control unit 80 detects attachment/detachment of a battery, the type of the battery, and a remaining battery level. Further, the power supply control unit 80 controls the DC-DC converter based on a result of the detection and an instruction by the system control unit 50, and thereby supplies a necessary voltage to each of the portions including the storage medium 200 for a necessary period. A power supply unit 30 is configured of, for example, a primary battery such as an alkaline battery or a lithium battery, or a secondary battery such as a nickel-cadmium (NiCd) battery, a nickel-metal hydride (NiMH) battery, or a lithium (Li) battery, or an alternating current (AC) adapter.

A storage medium interface (I/F) 18 is an interface with the storage medium 200 such as a memory card or a hard disk. The storage medium 200 is a recording medium such as a memory card for recording a captured image, and is configured of a device such as a semiconductor memory or a magnetic disk.

A communication unit 54 is connected wirelessly or by a cable, and transmits and receives image signals and audio signals. The communication unit 54 can also be connected to a wireless local area network (LAN) and to the Internet. The communication unit 54 can also communicate with an external apparatus based on Bluetooth® and Bluetooth Low Energy. The communication unit 54 can transmit an image (including the LV image) picked up by the image pickup unit 22, and an image recorded in the storage medium 200, and can also receive an image and other various kinds of information from the external apparatus.

An attitude detection unit 55 detects an attitude of the digital camera 100 relative to the gravity direction. Based on the attitude detected by the attitude detection unit 55, it is possible to determine whether an image picked up by the image pickup unit 22 is an image captured when the digital camera 100 is held in a landscape position, or an image captured when the digital camera 100 is held in a portrait position. The system control unit 50 can add orientation information based on the attitude detected by the attitude detection unit 55 to an image file of an image picked up by the image pickup unit 22, or can record a rotated image. For example, an acceleration sensor or a gyro sensor can be used as the attitude detection unit 55. A motion (including panning, tilting, lifting, and being still) of the digital camera 100 can also be detected by using the acceleration sensor or the gyro sensor serving as the attitude detection unit 55.

The eye approach detection unit 57 is an eye approach detection sensor that detects approach (eye approach) and separation (eye withdrawal) of the eye (object) 161 with respect to the eyepiece portion 16 of the viewfinder (approach detection). The system control unit 50 switches each of the display unit 28 and the EVF 29 between display (display state) and non-display (non-display state), based on a state detected by the eye approach detection unit 57. More specifically, at least in the image capturing standby state, and in a case where display-destination switching is automatic switching, the display unit 28 is brought into the display state to be the display destination, whereas the EVF 29 is brought into the non-display state, during the time when there is no approach of the eye.

During the eye approach state, the EVF 29 is brought into the display state to be the display destination, whereas the display unit 28 is brought into the non-display state. For example, an infrared proximity sensor can be used for the eye approach detection unit 57, so that approach of some kind of object toward the eyepiece portion 16 of the finder having the EVF 29 built therein can be detected. In a case where an object approaches, infrared light output from a light output portion (not illustrated) of the eye approach detection unit 57 is reflected, and the reflected light is received by a light receiving portion (not illustrated) of the infrared proximity sensor. Based on the amount of the received infrared light, a distance (an eye approach distance) from the eyepiece portion 16 to the approaching object can be determined. In this way, the eye approach detection unit 57 detects a proximity distance of the object to the eyepiece portion 16, i.e., performs the approach detection. In a case where an object approaching toward the eyepiece portion 16 starting from a non-eye-approach state (non-approach state) is detected to be within a predetermined distance, detection of the eye approach is determined. In a case where an object detected to be approaching has moved away starting from an eye approach state (an approach state) for a predetermined distance or more, detection of the eye withdrawal is determined. A threshold for detecting the eye approach and a threshold for detecting the eye withdrawal may be made different by, for example, providing a hysteresis. After the eye approach is detected, the eye approach state continues until the eye withdrawal is detected. After the eye withdrawal is detected, the non-eye-approach state continues until the eye approach is detected. The infrared proximity sensor is only an example, and other types of sensors may be employed for the eye approach detection unit 57, if this sensor can detect approach of an eye or object that can be regarded as the eye approach.

A viewpoint input setting unit 167 makes a setting for enabling or disabling viewpoint detection by the viewpoint detection circuit 165. Alternatively, the viewpoint input setting unit 167 makes a setting for enabling or disabling viewpoint-input-based processing by the system control unit 50. For example, the user can set the setting through a menu setting. The system control unit 50 can detect the following operations or states with respect to the eyepiece portion 16.
Input of a viewpoint that has not been input to the eyepiece portion 16 to the eyepiece portion 16 as a new viewpoint. In other words, start of a viewpoint input.
A state of inputting a viewpoint to the eyepiece portion 16.
A state of viewing to the eyepiece portion 16.
Removal of a viewpoint that has been input to the eyepiece portion 16. In other words, end of a viewpoint input.
A state of inputting no viewpoint to the eyepiece portion 16.

These operations and states as well as the position at which the viewpoint is input on the eyepiece portion 16 are notified to the system control unit 50 via an internal bus. The system control unit 50 determines what kind of operation (viewpoint operation) is performed on the eyepiece portion 16, based on the notified information.

The touch panel 70a and the display unit 28 can be integrally configured. For example, the touch panel 70a is configured to have a light transmittance of not obstructing the display of the display unit 28, and is attached to an upper layer of the display screen of the display unit 28. Input coordinates on the touch panel 70a and display coordinates on the display screen of the display unit 28 are associated with each other. This makes it possible to provide a graphical user interface (GUI) that enables the user to feel as if the user can directly operate a screen displayed on the display unit 28. The system control unit 50 can detect, for example, start of a touch by a finger or stylus pen on the touch panel 70a, a state of the touch, a movement of the touch, and release of the touch.

For the touch panel 70a, a touch panel employing any of various methods may be used. The various methods include a resistance film method, a capacitive method, a surface acoustic wave method, an infrared method, an electromagnetic induction method, an image recognition method, and an optical sensor method. Depending on the method, a touch is detected in a case where a touch panel is touched, or a touch is detected in a case where a finger or stylus pen approaches a touch panel, but either way may be employed.

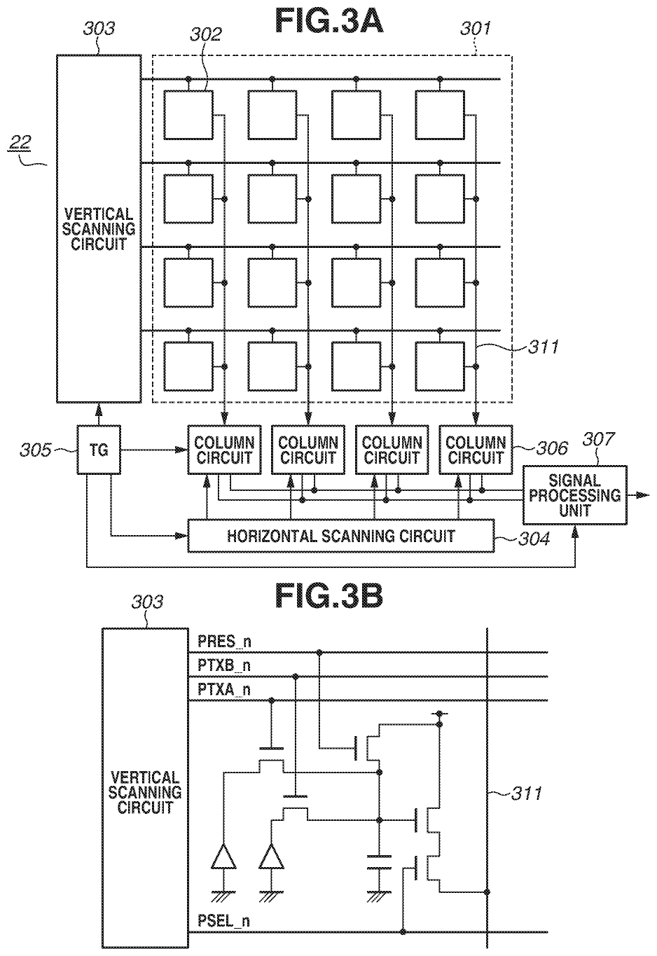

FIG. 3A is a block diagram illustrating a configuration of the image pickup unit 22 according to the present exemplary embodiment, and FIG. 3B illustrates a detailed configuration in the vicinity of a pixel 302. The configuration of the image pickup unit 22 will be briefly described with reference to FIGS. 3A and 3B. In a pixel region 301, a plurality of pixels 302 each including a photoelectric conversion unit is arranged in a horizontal direction and a vertical direction, in a matrix state. This represents each pixel. Only 4×4 pixels are arranged in a matrix as the pixels 302 in the pixel region 301, but in a real image sensor, tens of millions of such pixels are arranged. A plurality of pixels 302 is connected to a vertical output line 311 in the vertical direction. A column circuit 306 is connected to each of the vertical output lines 311. The column circuit 306 includes an A/D converter, a latch circuit, and a memory, and holds an analog signal as a digital signal. The analog signal may be converted into the digital signal by applying a gain to the analog signal, by providing an amplifier between the vertical output line 311 and the column circuit 306. Outputs of the column circuit 306, i.e., the digital signals held by the memory, are sequentially selected by a horizontal scanning circuit 304, and the data of the number of pieces corresponding to the number of pixels in the horizontal direction are input to a signal processing unit 307. A timing generator (TG) 305 supplies a control signal generated for each of a vertical scanning circuit 303, the horizontal scanning circuit 304, the column circuit 306, and the signal processing unit 307.

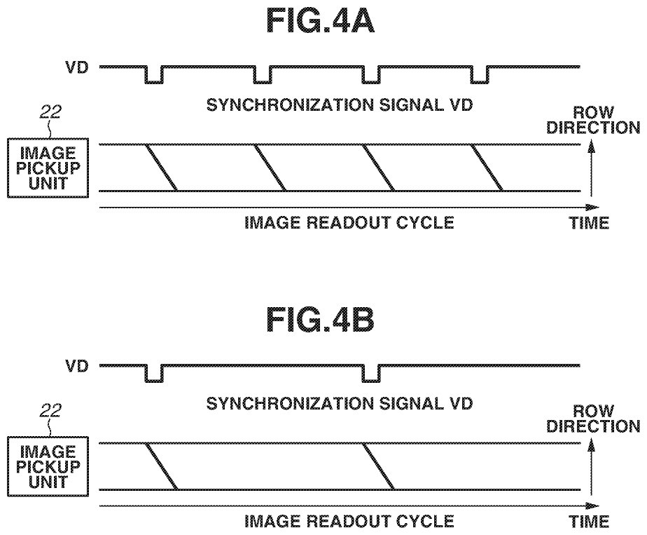

FIGS. 4A and 4B are diagrams each illustrating a frame rate for display of the live view image. FIG. 4A illustrates a synchronization signal VD to the display unit 28 or the EVF 29 and an image readout cycle to the image pickup unit 22, when the frame rate is 120 HZ. FIG. 4B illustrates the synchronization signal VD to the display unit 28 or the EVF 29 and the image readout cycle to the image pickup unit 22, when the frame rate is 60 HZ. The synchronization signal VD indicates timing for update of the display. The image readout cycle indicates the relationship between an actual image readout cycle and the image pickup unit 22. In each of FIGS. 4A and 4B, a horizontal axis indicates the time, and a vertical axis of the image readout cycle indicates a row direction of the image pickup unit 22. For example, in a case where the frame rate of a normal live view image is 120 HZ, an amount of processing for updating the display is halved if the frame rate is changed to 60 HZ, so that power consumption can be reduced. It is needless to say that the frame rate is not limited to the above case. In a case where the frame rate is to be reduced, the frame rate may only be made less than the original frame rate, instead of being halved. The frame rate may be changed by controlling the timing for updating the display in the display unit 28 or the EVF 29, or by controlling timing for reading out an image (acquisition) to the image pickup unit 22.

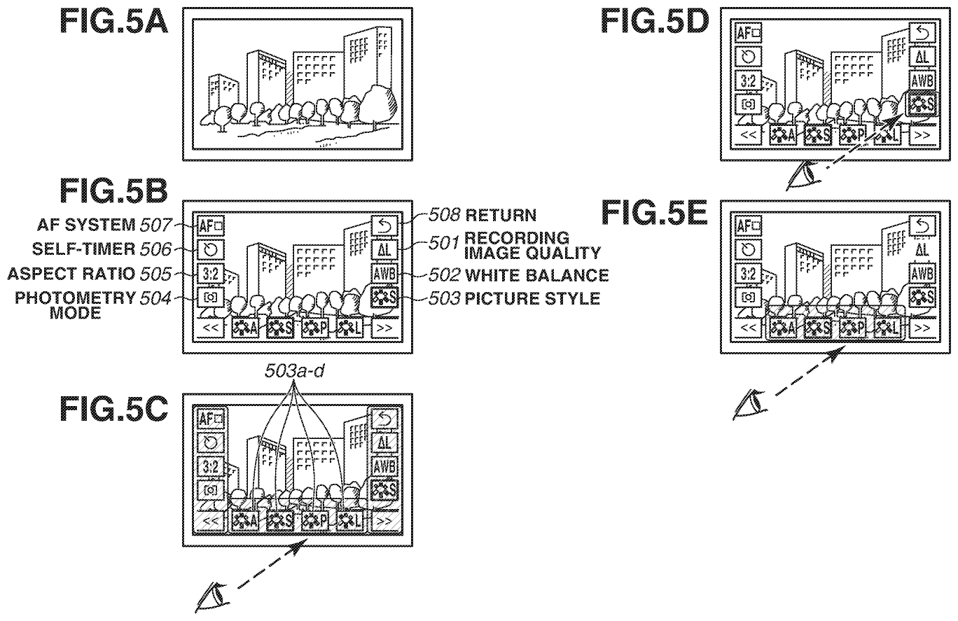

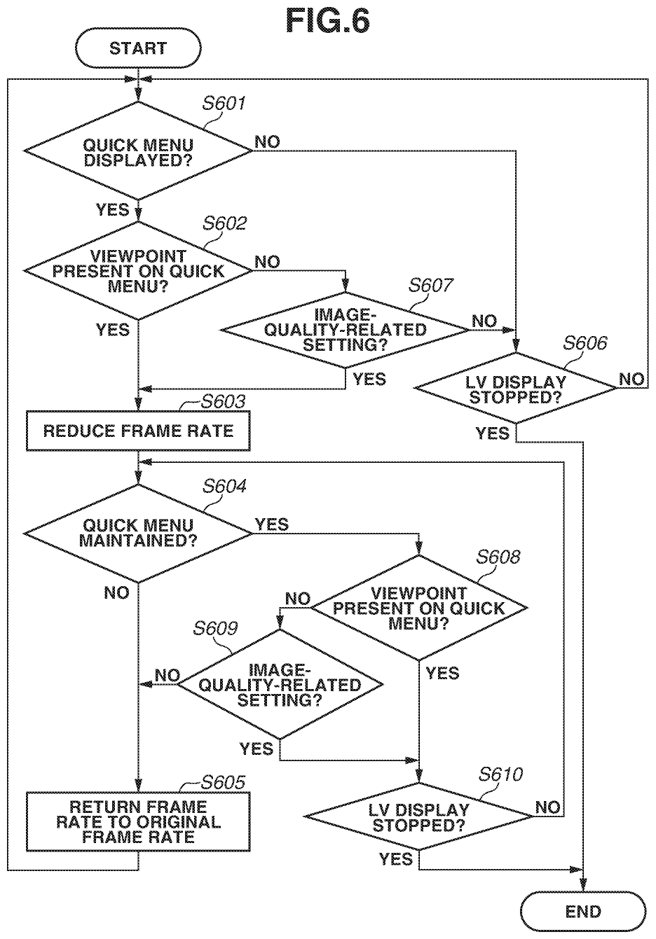

Display control processing for the live view image in the present exemplary embodiment will be described below with reference to FIGS. 5A, 5B, 5C, 5D, 5E, and FIG. 6.

The system control unit 50 loads the program stored in the nonvolatile memory 56 into the system memory 52 to execute the program, and thereby controls each function block, so that each step of processing in the flowchart in FIG. 6 is implemented. The flowchart in FIG. 6 starts, when the digital camera 100 is activated, and the live view image (LV image) is displayed on the display unit 28 or the EVF 29 as illustrated in FIG. 5A. The frame rate of the LV image display at this time is defined as a frame rate A.

In step S601, the system control unit 50 determines whether a quick menu is displayed by pressing the Q button 70c during the LV display on the display unit 28 or the EVF 29. In a case where the Q button 70c is pressed i.e., in a case where a display instruction is received, the quick menu illustrated in FIG. 5B is displayed on the display unit 28 or the EVF 29. If the quick menu is displayed while the LV image is displayed on the EVF 29 (YES in step S601), the processing proceeds to step S602. If the quick menu is not displayed while the LV image is displayed on the EVF 29 (NO in step S601), the processing proceeds to step S606. If the quick menu is displayed while the LV image is displayed on the display unit 28 (YES in step S602), the processing proceeds to step S602. If the quick menu is not displayed while the LV image is displayed on the display unit 28 (No in step S601), the processing proceeds to step S606.

In step S602, the system control unit 50 determines whether a viewpoint input is present on the quick menu displayed on the EVF 29. Specifically, the viewpoint detection circuit 165 performs the determination in step S602. If the viewpoint input is present (YES in step S602), the processing proceeds to step S603. If the viewpoint input is not present (NO in step S602), the processing proceeds to step S607. The viewpoint input in step S602 will be described with reference to FIGS. 5B and 5C. After the quick menu is displayed as illustrated in FIG. 5B, the user moves the viewpoint to the menu, in a case where the user is to perform setting. Whether the viewpoint input is present on the quick menu is determined in step S602 of the present exemplary embodiment, by detecting whether a user is gazing at a shaded portion in FIG. 5C. Of course, a region for determining presence of gaze varies in terms of shape and area, depending on a menu configuration. Further, the above-described gaze may be applied to only a region where an item is displayed, or a peripheral portion of the region where the item is displayed may also be included. If the user is gazing at the shaded portion, the user is highly likely to be paying attention to the display of the LV image. Therefore, in step S603, processing for reducing the frame rate is performed. In this way, the power consumption can be reduced. In a case where an image pickup unit that can detect a viewpoint of the user toward the display unit 28 is provided on the display unit 28 side, the processing in step S602 may be performed in a case where the LV image is displayed on the display unit 28. In this way, whether smoothness of the display of the LV image is desired by the user is determined with higher accuracy by detecting the viewpoint input of the user, and power is saved in a case where it is highly likely that the smoothness is not desired by the user.

In step S603, the system control unit 50 changes the frame rate of the LV image to be displayed on the display unit 28 or the EVF 29 to a frame rate B that is lower than the frame rate at the start of the flowchart in FIG. 6. In other words, a relation of A>B is established.

In step S604, the system control unit 50 determines whether the display of the quick menu on the display unit 28 or the EVF 29 is maintained. If the display of the quick menu is maintained (YES in step S604), the processing proceeds to step S608. If the display of the quick menu is not maintained (NO in step S604), the processing proceeds to step S605. The display of the quick menu can be stopped by selecting a return icon 508 in FIG. 5B. In this way, in step S604, the system control unit 50 may determine that the display of the quick menu is not maintained. Alternatively, the system control unit 50 may determine the result to be NO, in response to a movement of a cursor toward the return icon 508.

In step S605, the system control unit 50 returns the frame rate of the LV image display on the display unit 28 or the EVF 29 to the original frame rate A. In step S605, it is highly likely that the display of the quick menu is finished and the user is viewing the LV image, and thus visibility of the LV image is improved by increasing the frame rate to the frame rate A. In step S605, the frame rate may be increased in response to detection of gazing at the LV image by the user, or may be gradually increased based on the time during which the user continues gazing at the LV image.

In step S606, the system control unit 50 determines whether the LV display on the display unit 28 or the EVF 29 is stopped. If the system control unit 50 determines that the LV display is stopped (YES in step S606), the flowchart ends. If the system control unit 50 determines that the LV display is not stopped (NO in step S606), the processing returns to step S601.

In step S607, the system control unit 50 determines whether image-quality-related setting is being changed on the quick menu. The image-quality-related setting corresponds to a recording image quality item 501, a white balance item 502, and a picture style item 503 for changing a color shade of an image, in FIG. 5B. If any of these items is selected, the result of the determination in step S607 is YES. If any of a photometry mode item 504, an aspect ratio item 505, a self-timer item 506, and an AF system item 507 is selected, the result of the determination in step S607 is NO. Although not illustrated in FIG. 5B, if a shutter speed item or an International Organization for Standardization (ISO) sensitivity item is selected, the result of the determination in step S607 may be YES. When the user performs setting for the photometry mode, the aspect ratio, the self-timer, and the AF system, an influence on the setting is small even if the user does not observe details of the state of a subject. For example, in the case of the self-timer, the user can often determine a required time, even if the user does not know details of the state of the subject or the color tone of the subject, or even if the subject is not moving smoothly. If the system control unit 50 determines that the image-quality-related setting is being changed (YES in step S607), the processing proceeds to step S603. If the system control unit 50 determines that the image-quality-related setting is not being changed (NO in step S607), the processing proceeds to step S606.

In step S608, the system control unit 50 performs determination similar to that in step S602. If a viewpoint input is present on the quick menu (YES in step S608), the processing proceeds to step S610. If a viewpoint input is not present on the quick menu (NO in step S608), the processing proceeds to step S609.

In step S609, the system control unit 50 performs determination similar to that in step S607. If the image-quality-related setting is being changed on the quick menu (YES in step S609), the processing proceeds to step S610. If the image-quality-related setting is not being changed on the quick menu (NO in step S609), the processing proceeds to step S605.

In step S610, the system control unit 50 performs determination similar to that in step S606. If the system control unit 50 determines that the LV display is stopped (YES in step S610), the flowchart in FIG. 6 ends. If the system control unit 50 determines that the LV display is not stopped (NO in step S610), the processing returns to step S604.

As described above, according to the present exemplary embodiment, it is possible to reduce the power consumption, without reducing visibility when the user views the LV image.

In the above-described exemplary embodiment, the display frame rate is described to be reduced. However, the power may be saved by decreasing a readout amount by thinning out the pixels 302 to be read out from the image pickup unit 22, pixel by pixel, or row by row.

In step S602 and step S608, the system control unit 50 may determine whether the user is gazing at the image-quality-related setting of the quick menu as illustrated in FIG. 5D, in a case where the quick menu is displayed on the EVF 29. Alternatively, the system control unit 50 may determine whether the user is gazing at child items in the hierarchy of the quick menu as illustrated in FIG. 5E. In the above-described exemplary embodiment, in a case where the LV image is displayed on the display unit 28, whether to change the frame rate is determined as a result of the determination in each of steps S602 (S608) and steps S607 (S609). However, whether to change the frame rate may be determined based on only the determination in steps S602 and S608.

Alternatively, whether to change the frame rate may be determined based on only the determination in steps S607 and S609, in a case of a screen where menu items are initially displayed.

Further, in the above-described exemplary embodiment, whether to change the frame rate is determined as a result of the determination in each of step S601 (S604), step S602 (S608), and step S607 (S609), in a case where the LV image is displayed on the EVF 29. However, whether to change the frame rate may not be determined based on the determination in each of all these steps. Whether to change the frame rate may be determined based on the determination in any one of these steps or a combination of some of these steps. For example, in the case of a screen where menu items are initially displayed, whether to change the frame rate may be determined based on only the determination in step S607 (S609).

The frame rate may be reduced, based on detection of a transition from the eye-approach state to the non-eye-approach state, and detection of a downward attitude (a state where an image pickup direction of the lens unit 150 has changed to a direction toward the ground) of the digital camera 100 by the attitude detection unit 55. In a case where the user changes from a state of looking in the finder to a state of holding the digital camera 100 directed downward upon taking the eye off the finder, it is highly likely that the user intends to change the setting. At this moment, it is highly likely that the user intends to view the setting item, instead of viewing the subject that is a target for image capturing. Therefore, the power can be saved by reducing the frame rate.

Furthermore, in a case where the LV image is displayed on the display unit 28 or the EVF 29, the frame rate is increased, if an AF frame is moved even though the quick menu is displayed. The user can move the AF frame by performing, for example, a touch operation on the touch panel 70a, or an operation on the cross key 74 in each direction.

In the above-described exemplary embodiment, whether the user is gazing at the quick menu is determined in steps S602 and S608 is described. This case is not limitative, and the frame rate may be reduced based on a gazing time period. Further, the frame rate may be increased based on a time period during which the user is gazing at the LV image.

For the quick menu item, the setting value can be changed by an operation for selecting the displayed item. In a case where an operation for changing the setting value is disabled even if the displayed item is selected in the LV image, such as a case where the current time or the number of images that can be captured is selected, the frame rate may not be changed even if the item is displayed.

A single piece of hardware may perform the above-described various kinds of control described to be performed by the system control unit 50, or a plurality of pieces of hardware may control the entire apparatus by sharing the processing.

The present disclosure is described in detail with reference to some exemplary embodiments, but the present disclosure is not limited to these specific exemplary embodiments, and includes various forms without departing from the gist of the present disclosure. Further, each of the above-described exemplary embodiments is only an exemplary embodiment of the present disclosure, and the exemplary embodiments can be combined as appropriate.

Furthermore, in the above-described exemplary embodiments, the case where the present disclosure is applied to the digital camera 100 is described as an example, but the present disclosure is not limited to this example, and is applicable to any type of display control apparatus, if the display control apparatus can control changing of the frame rate. For example, the present disclosure is applicable to a wearable apparatus such as a head mounted display with a camera, a mobile phone, a game console, and an electronic book reader. Further, in order to save the power, for example, an information amount may be reduced by addition, or a readout bit length may be reduced, at the time of readout from the image pickup unit 22. The power may be saved by changing a display method from a progressive type to a doubler or interlace type.

The present disclosure may also be implemented by executing the following processing. Software (program) that implements the functions of each of the above-described exemplary embodiments may be supplied to a system or apparatus via a network or various storage media, and a computer (e.g., a central processing unit (CPU), a micro processing unit (MPU), or the like) of the system or apparatus may read out a program code and executes the read-out program code, so that the processing is performed. In this case, the program and the storage medium storing the program may be included in the present disclosure.

According to the exemplary embodiments of the present disclosure, the power in displaying the live view image on the display unit can be reduced.

### OTHER EMBODIMENTS

Embodiment(s) of the present disclosure can also be realized by a computerized configuration(s) of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computerized configuration(s) of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computerized configuration(s) may comprise one or more processors, one or more memories, circuitry, or a combination thereof (e.g., a central processing unit (CPU), a micro processing unit (MPU), or the like), and may include a network of separate computers or separate processors to read out and execute the computer executable instructions. The computer executable instructions may be provided to the computerized configuration(s), for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2019-080189, filed Apr. 19, 2019, which is hereby incorporated by reference herein in its entirety.

What is claimed is:

1. A display control apparatus comprising:
a display control unit configured to perform control to display a live view image acquired from an image pickup unit on a display unit;
a receiving unit configured to receive an instruction to display a first item on the display unit, in a case where the live view image is being displayed on the display unit; and
a control unit configured to control a frame rate for displaying the live view image to be lower in a case where the first item is displayed on the display unit, than in a case where the first item is not displayed on the display unit.

2. A display control apparatus comprising:
a display control unit configured to perform control to display a live view image acquired from an image pickup unit on a display unit;
a detection unit configured to detect a viewpoint of a user onto the display unit; and
a control unit configured to control a frame rate for displaying the live view image to be lower in a case where a viewpoint of the user onto a first item displayed on the display unit is detected, than in a case where a viewpoint of the user onto the first item displayed on the display unit is not detected.

3. A display control apparatus comprising:
a display control unit configured to perform control to display a live view image acquired from an image pickup unit on a display unit;
a selection unit configured to select a first item or a second item on the display unit, in a case where the live view image is being displayed on the display unit; and
a control unit configured to control a frame rate for displaying the live view image to be lower in a case where the first item is selected by the selection unit, than in a case where the second item is selected by the selection unit.

4. The display control apparatus according to claim 3, further comprising a receiving unit configured to receive an instruction to display the first item and the second item on the display unit, in a case where the live view image is being displayed on the display unit,
wherein the control unit controls the frame rate for displaying the live view image to be lower in a case where the first item is displayed on the display unit, than in a case where the first item is not displayed on the display unit.

5. The display control apparatus according to claim 1, further comprising a detection unit configured to detect a viewpoint of a user onto the display unit,
wherein the control unit controls the frame rate for displaying the live view image to be lower in a case where a viewpoint of the user onto the first item displayed on the display unit is detected, than in a case where a viewpoint of the user onto the first item displayed on the display unit is not detected.

6. The display control apparatus according to claim 1, wherein the first item is a setting item relating to quality of the live view image displayed on the display unit.

7. The display control apparatus according to claim 1, wherein the first item is one of a recording image quality, a white balance, a picture style, an International Organization for Standardization (ISO) sensitivity, and a shutter speed.

8. The display control apparatus according to claim 1, wherein the second item is one of an automatic focus (AF) system, a self-timer, an aspect ratio, and a photometry mode.

9. The display control apparatus according to claim 1, wherein the control unit controls the frame rate for displaying the live view image to be higher in response to a transition of the first item on the display unit to a non-display state.

10. The display control apparatus according to claim 1, wherein the control unit controls the frame rate for displaying the live view image by changing a frame rate for acquiring the live view image by the image pickup unit, or changing a frame rate for updating display of the display unit.

11. The display control apparatus according to claim 1, wherein the control unit controls the frame rate for displaying the live view image on the display unit to reduce the frame rate in response to an increase in time period of gazing at the first item by a user.

12. The display control apparatus according to claim 1, wherein the control unit controls the frame rate for displaying the live view image on the display unit to be higher in response to an increase in time period of gazing at the live view image by a user.

13. The display control apparatus according to claim 1, wherein the control unit reduces an information amount of an image to be read out from the image pickup unit, in a case where the control unit changes the frame rate for displaying the live view image on the display unit.

14. A control method of a display control apparatus, the control method comprising:
performing control to display a live view image acquired from an image pickup unit on a display unit;
receiving an instruction to display a first item on the display unit, in a case where the live view image is being displayed on the display unit; and
controlling a frame rate for displaying the live view image to be lower in a case where the first item is displayed on the display unit, than in a case where the first item is not displayed on the display unit.

15. A control method of a display control apparatus, the control method comprising:
performing control to display a live view image acquired from an image pickup unit on a display unit;
detecting a viewpoint of a user onto the display unit; and
controlling a frame rate for displaying the live view image to be lower in a case where a viewpoint of the user toward a first item displayed on the display unit is detected, than in a case where a viewpoint of the user onto the first item displayed on the display unit is not detected.

16. A control method of a display control apparatus, the control method comprising:
performing control to display a live view image acquired from an image pickup unit on a display unit;
selecting a first item or a second item on the display unit, in a case where the live view image is being displayed on the display unit; and
controlling a frame rate for displaying the live view image to be lower in a case where the first item is selected, than in a case where the second item is selected.

17. A computer-readable storage medium that stores a program for causing a computer to execute a control method of a display control apparatus, the control method comprising:
performing control to display a live view image acquired from an image pickup unit on a display unit;
receiving an instruction to display a first item on the display unit, in a case where the live view image is being displayed on the display unit; and
controlling a frame rate for displaying the live view image to be lower in a case where the first item is displayed on the display unit, than in a case where the first item is not displayed on the display unit.
